(19) United States
(12) Patent Application Publication
(10) Pub. No.: US 2005/0205122 A1
(43) Pub. Date: Sep. 22, 2005

(54) Glide cap for walker

(76) Inventors: Robert R. Bly, Wellington, OH (US); Christopher H. Delgado, Stow, OH (US); Kevin Wysocki, Grafton, OH (US); John Lescher, Sheffield Village, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/971,240

(22) Filed: Oct. 22, 2004

Related U.S. Application Data
(60) Provisional application No. 60/553,701, filed on Mar. 16, 2004.

(51) Int. Cl. A45B 1/02; A61H 3/02; A63B 53/04; A63B 53/06; A63B 53/08

(52) U.S. Cl. 135/85

(57) ABSTRACT

The present invention relates in one aspect to a glide tip for a leg of a personal mobility aid. The glide tip includes a holder, and a replaceable ball supported on the leg by the holder. The ball may be rotatable relative to the holder about a plurality of axes. The ball may be a sports ball, such as a tennis ball.

### RELATED APPLICATION

This application claims the benefit of U.S. Provisional Application No. 60/553,701, the entire disclosure of which is hereby incorporated by reference.

### TECHNICAL FIELD

This application relates to personal mobility aids, such as walkers. In particular, this application relates to a glide tip or a glide tip assembly for use on or as part of a walker or other personal mobility aid.

### BACKGROUND OF THE INVENTION

Walkers are known in the art as an aid for individuals who require support while walking. When using a walker, an individual grasps the walker at the hand grips, lifts and repositions the walker in front of them, then steps toward the walker while using the walker to support a portion of their weight. During this process, the walker leg tips often come in contact with the floor while the walker is moving forward. Thus, the rear legs can drag if the user does not lift them sufficiently or if the user sets the rear legs down while the walker still has some forward movement. This contact can (1) interfere with smooth, forward movement of the walker, (2) create an unwanted vibration in the walker, and (3) create unwanted noise.

Individuals have attempted to solve these problems by placing a tennis ball on the end of each of a walker's rear legs, as a glide cap. This is done by forming a cross-shaped slice in the tennis ball then pushing the tennis ball over the rear leg tip and onto the walker rear leg. Once the tennis ball is over the tip of the walker leg, the outer surface of the tennis ball, not the walker tip, comes in contact with the ground surface. The tennis ball surface, which is flocked, reduces the friction between the walker rear legs and the ground surface, thus allowing smooth, forward movement and reduced noise. This solution, however, is temporary because continued use of the walker results in wear on the outer surface of the tennis ball. As the wear continues, the problems return.

### SUMMARY OF THE INVENTION

The present invention relates in one aspect to a glide tip for a leg of a personal mobility aid. The glide tip includes a holder, and a replaceable ball supported on the leg by the holder. The ball may be rotatable relative to the holder about a plurality of axes. The ball may be a sports ball, such as a tennis ball.

### BRIEF DESCRIPTION OF THE DRAWINGS

FIG. 1 is a perspective view of a personal mobility aid in the form of a walker, including a glide tip assembly that is a first embodiment of the invention;

FIG. 2 is an enlarged view of a portion of the walker of FIGS. 1, showing the glide tip assembly;

FIG. 3 is an exploded perspective view of the glide tip assembly;

FIG. 4 is an enlarged view of a holder that forms part of the glide tip assembly;

FIG. 5 is a sectional view of the holder of FIG. 4;

FIGS. 6 and 7 are sectional views showing parts of the glide tip assembly in different positions;

FIG. 8 is a partial sectional view of a glide tip in accordance with another embodiment, which includes a stopper for limiting ball movement;

FIG. 9 is a perspective view of a holder that is another embodiment of the invention;

FIG. 10 is a sectional view of the holder of FIG. 9;

FIG. 11 is a perspective view of a holder that is yet another embodiment of the invention;

FIGS. 12 and 13 are sectional views of a glide tip in accordance with another embodiment, which includes a height adjuster mechanism, and showing parts of the glide tip assembly in different positions; and

FIGS. 14-16 are sectional views of portions of other glide tip assemblies that are constructed in accordance with further embodiments of the invention.

### DETAILED DESCRIPTION

This application relates to personal mobility aids, such as walkers. In particular, this application relates to a glide tip or a glide tip assembly for use on or as part of a walker or other personal mobility aid, which can take various different configurations.

FIG. 1 shows a personal mobility aid in the form of a walker 12, with a sports ball glide tip assembly 10 in accordance with a first embodiment of the present invention. The invention is usable with other types of walkers and with other personal mobility aids, such as a rolling seat device.

The walker 12 shown in FIG. 1 includes a pair of side frames 14 of tubular construction. Each side frame 14 includes a front leg 16 and a rear leg 18. Each side frame 14 also includes an upper brace 20 and a side brace 22 that extend transversely between the front and rear legs 16, 18 to connect and support the legs. The upper brace 20 of each side frame 14 is provided with a hand grip portion 24 that a user may grasp while using the walker 12. A front cross brace 26 interconnects the side frames 14, creating a structure that is closed in the front and open in the back.

Each front leg 16 is illustrated as including a swivel wheel 28, or caster, for engagement with the ground. The front legs 16, however, may alternatively use a fixed wheel, a conventional walker tip, or any other walker tip device, including a glide tip assembly, for engagement with the ground.

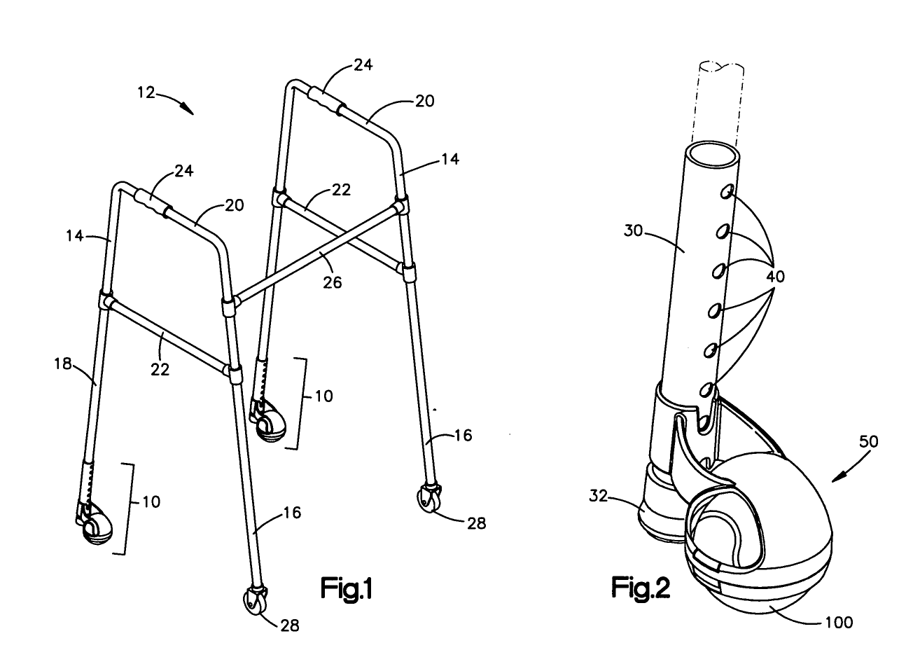

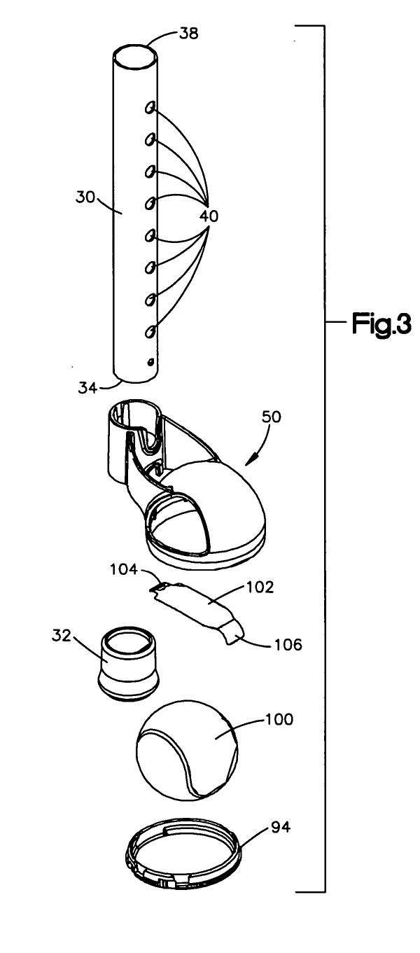

Each rear leg 18 is illustrated as including a glide tip assembly 10. Each glide tip assembly 10 (FIGS. 2-3) includes a lower leg portion 30, together with a holder 50 (described below) and a ball 100. The ball 100 is preferably but not necessarily a sports ball, such as a tennis ball.

As with the typical leg of a walker 12, the lower leg portion 30 (FIG. 2) of each glide tip assembly 10 is tubular in construction and may include a non-slip tip 32 positioned over the lower end 34 as the ground engaging portion of the lower leg portion 30. The upper end 38 of the lower leg portion 30 is open, and the lower leg portion's diameter is slightly greater than the diameter of the walker leg 18. In this manner, the lower leg portion 30 is slidably received over the lower section of the walker leg 18 in a telescoping fashion. This telescoping engagement allows for height adjustment of the walker 12 via a spring loaded button (not shown) that can be positioned in a series of holes 40 along the lower leg portion 30.

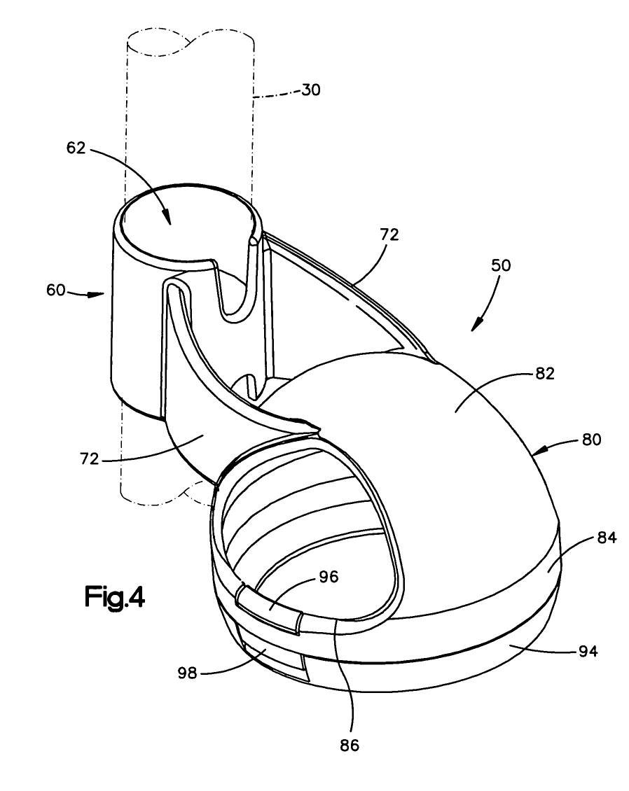

The holder 50 (FIGS. 4-5) includes a leg attachment portion 60, a connecting portion, and an enclosing portion 80. In the illustrated holder, the enclosing portion 80 is offset from the lower leg portion 30 (from the axis 81 of the lower leg portion 30). In other embodiments, however, the enclosing portion 80 of the holder 50 may be located along the lower leg portion 30 (the axis 81 of the lower leg portion 30) as illustrated in FIGS. 14-16, for example, discussed in detail below.

The leg attachment portion 60 has a bore 62 for receiving the lower leg portion 30. The bore diameter of the bore 62 is slightly larger than the diameter of the lower leg portion 30, so that a frictional fit between the bore and the lower leg portion can be the sole means of attaching the holder 50 to the lower leg portion 30. Alternatively, the holder 50 can be secured by fasteners, threads, adhesive, or otherwise. The holder 50 could, of course be alternatively directly connected to the walker leg itself.

The enclosing portion 80 of the holder 50 is joined to the leg attachment portion 60 of the holder by the connecting portion of the holder. In the embodiment shown in FIG. 4, the connecting portion is formed as two arms 72 of rectangular cross-section extending outward from the leg attachment portion 30 and connecting with the enclosing portion 80 near its top.

The enclosing portion 80 has a generally hemispherical overall configuration including a domed top wall 82 and a generally ring-shaped side wall 84. The side wall 84 is located at the bottom of the top wall 82 and extends for 360 degrees around the top wall 82. The top wall 82 has two large cutouts or access openings 86 on opposite sides of the arms 72, thus providing the top wall 82 with a C-shaped configuration as viewed from the side (for example, as viewed in FIG. 5). The top wall 82 has a concave inner surface 88.

The top wall 82 and the side wall 84 of the holder 50 together define a chamber 90 in the enclosing portion 80 of the holder, for receiving the ball 100. The side wall 84 defines a bottom opening 92 into the chamber 90 for inserting and removing the ball 100. The access openings 86 in the top wall 82 of the enclosing portion 80 of the holder 50 help to enable removal of the ball 100 from the holder 50, as described below.

When the ball 100 is in the chamber 90, the inner surface of the top wall 82 of the holder 50 extends at least partially around the ball 100. The side wall 84 of the enclosing portion 80 is adapted to retain the ball 100 in the chamber 90. The side wall 84 has a lip or ridge 93 with an inner diameter that is less than the outer diameter of the ball 100 at its equator. As a result, the side wall 84 functions as a retaining structure to retain the ball 100 in the chamber 90. A variety of different retaining structures can be used to facilitate retaining the ball 100 within the chamber 90. FIGS. 11 and 14 illustrate alternative embodiments and are discussed below.

For ease of manufacturing, the retaining structure illustrated in FIG. 5 is included in a separate ring portion 94 of the holder 50, for removable attachment to the top wall 82 of the enclosing portion 80. The ring portion 94 is removably attached by use of tabs 96 on the ring portion 94 that have a snap engagement with portions 98 on the enclosing portion 80. Other means and methods of attaching such a separate portion can be used. Alternatively, the retaining structure can be formed as one piece with the other parts of the enclosing portion 80 of the holder 50, for example, as shown in FIGS. 10-11 discussed below.

The holder 50, in the embodiment illustrated in FIGS. 3 and 5, also includes a spring 102 positioned to act between the sports ball 100 and the holder 50. The spring 102 may consist of an elastic device, such as a metal or plastic strip or coil of wire, or an elastomer. In the embodiment of FIG. 5, the spring 102 is a metal strip with a fixed end 104 and a free end 106. The fixed end 104 is fixedly attached to the inner surface 88 of the holder 50 by an end tab 104 inserted in a slot 108 in the holder 50. The spring 102 extends across the chamber 90, and the free end 106 abuts the holder inner surface 88 at the opposite side. The ball 100 when in the chamber 90 contacts the spring 102 at approximately the spring's mid-point.

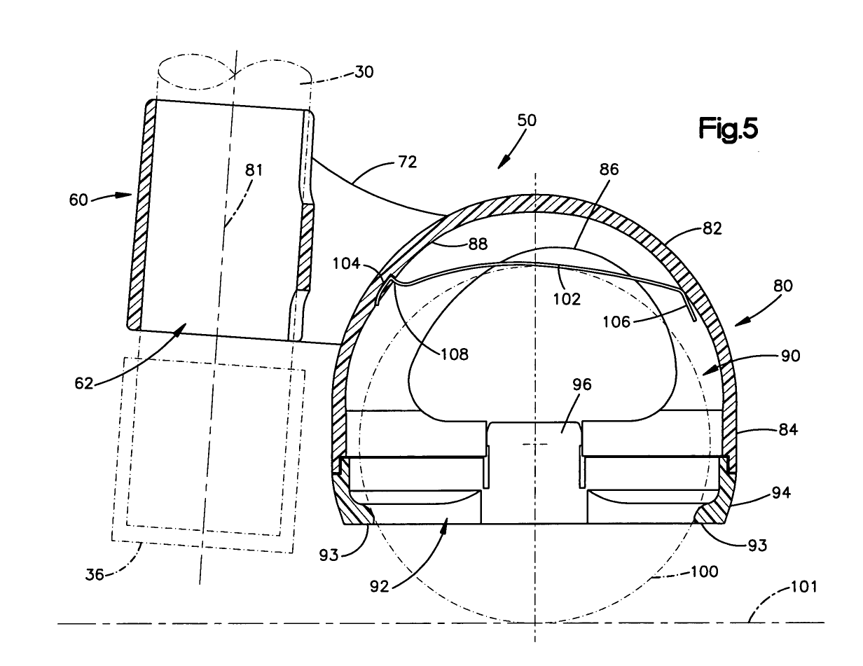

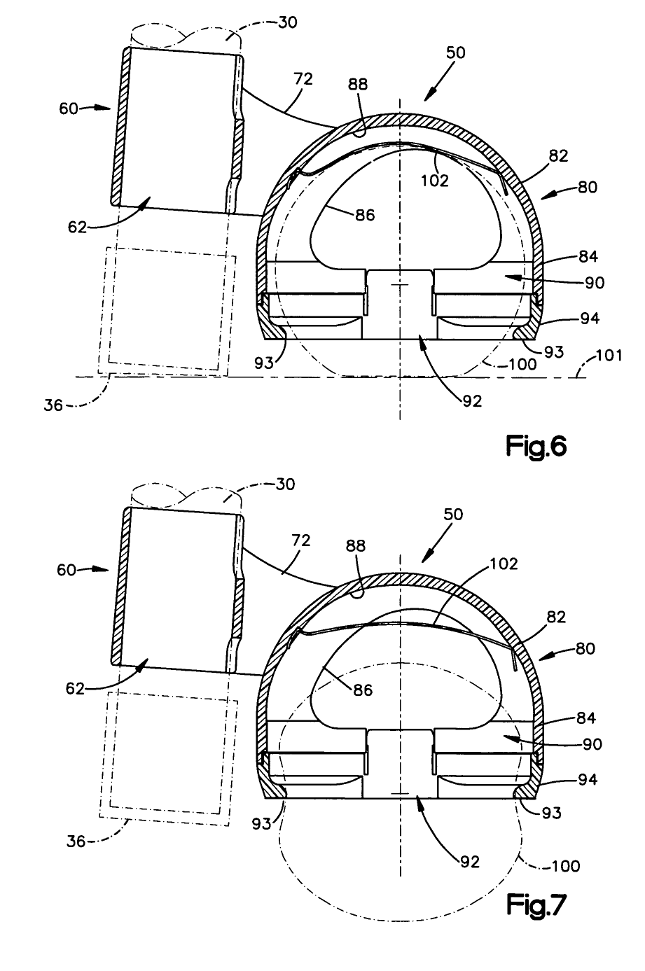

The chamber 90 is sized to allow the ball 100 to move between a first position, as shown in FIG. 5, and a second position, as shown in FIG. 6. When the ball 100 is in the first position, the spring 102 biases the ball against the lip 93, as shown in FIG. 5, so that a portion of the ball extends outward from the holder opening 92. The ball 100 is retained in the chamber 90 by the ring 94, but may rotate relatively freely within the chamber 90 about a plurality of axes (not merely one axis or one axle), restricted only by frictional contact with the spring 102 and the retaining structure 93. The ball 100 moves (retracts into the holder 50) to a second position (FIG. 6) when a sufficient force is applied to the ball to overcome the spring force acting on the ball. The chamber 90 is large enough to allow the spring 102 to deflect away from the opening 92 and thereby allow the ball 100 to retract into the holder 50, as described below in detail.

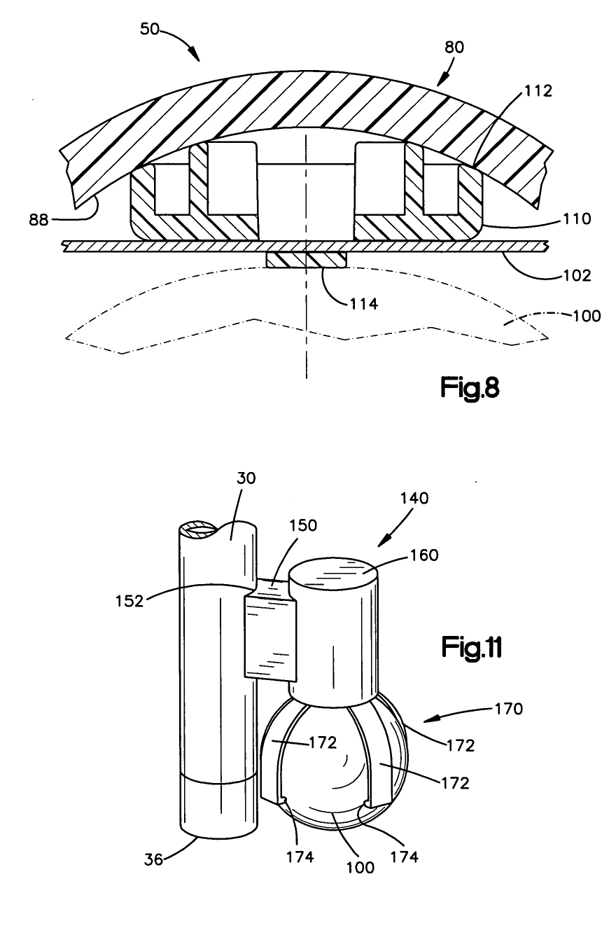

If the user does not wish the ball 100 to retract into the holder 50, the user may use a lockout mechanism for selectively limiting retraction of the ball. In FIG. 8 the lockout mechanism is illustrated as a disc-shaped stopper 110 that is inserted between the ball 100 and the holder 50. As illustrated, the stopper 110 is provided with a portion of its outer surface 112 that conforms with an inner surface 88 of the enclosing portion 80. The stopper 110 includes a clip 114 which engages the spring 102. The clip 114 couples the stopper 110 to the spring 102, allowing the spring to secure the stopper in position relative to the enclosing portion 80 within the chamber 90.

The holder 50 is designed to allow the ball 100 to be easily replaceable. As shown in FIG. 7, the user may remove the ball 100 by applying force to the ball to move the ball in the direction of the ball opening 92. To facilitate removal of the ball 100 in this manner, the enclosing portion 80 is provided with the two access openings 86. The user may apply the necessary force in the appropriate direction through one or both of the access openings 86, to roll or otherwise force the ball 100 out of the chamber 90. The inner diameter of the holder lip 93 is selected to retain the ball 100 in the holder 50 during usage, while enabling the ball to be easily removed when desired. To insert the ball 100 into the chamber 90, the user may, as shown in FIG. 7, compress the ball sufficiently to reduce the diameter of the ball to less than the diameter of the ball opening 92. In this manner, the ball 100 may be inserted into the chamber 90.

The glide tip assembly 10 is installed on the walker 12 so that when the ball 100 is in the first position it engages the ground 101 and thus supports the ground engaging portion 36 of the leg 30 spaced apart from the ground 101. When a sufficient downward force, such as the user's weight, is applied to the walker 12, the ball 100 retracts to the second position, bringing the ground engaging portion 36 of the lower leg portion 30 into contact with the ground 101. The ground engaging portion 36 provides a slide resistant interface with the ground 101, increasing the stability of the walker 12 while under load.

During the ordinary course of movement of the walker 12 across the ground surface 101, the ball 100 may be in sliding contact with the ground surface or in rolling contact with the ground surface, depending on the amount of friction between the ball and the ground surface. For example, if the ball 100 is a tennis ball with a flocked surface, then on relatively smooth ground surfaces 101 such as linoleum or tile, the friction between the tennis ball and the ground surface is not sufficient to overcome the friction between the tennis ball and the holder 50 (including the spring 102). As a result, the tennis ball 100 slides across the ground surface 101 when the walker 12 moves horizontally. The flocked surface and the resilience of the tennis ball 100 help the walker 12 to move in a smooth, quiet fashion.

If the tennis ball 100 is used on a relatively rough ground surface 101, such as carpet or concrete, the friction between the tennis ball and the ground surface is greater than the friction between the tennis ball and the holder 50 (including the spring 102). As a result, the tennis ball 100 rolls along the ground surface 101 when the walker 12 moves horizontally. The rolling contact helps the walker 12 to move in a smooth, quiet motion. Further, because the ball 100 is retained within the holder 50 without the use of an axle, the ball rotates about a plurality of axes, allowing the smooth, quiet rolling motion to be achieved in any direction. There is no chatter as might occur with a caster or other device during sideways movement. The rolling (rather than sliding) movement of the ball 100 over the rough surface 101 also limits abrasion of the ball outer covering and thus helps to lengthen the life of the ball as used in the glide tip 10.

If a ball 100 with a different outer surface is used, the nature of contact between the ball and the ground surface 101 may change. For example, if a rubber-surfaced ball 100, such as a racquetball, is used on the aforementioned relatively smooth surface 101, the friction between the rubber surface of the racquet ball and the ground surface is increased and could be sufficient to overcome the internal friction of the ball and the holder 50. As a result, the rubber ball 100 could roll along the ground surface 101 when the walker 12 moves horizontally. Thus, the movement of the walker 12 can be customized by selection of the particular ball or sports ball 100 and/or the tension applied by the spring 102 tension.

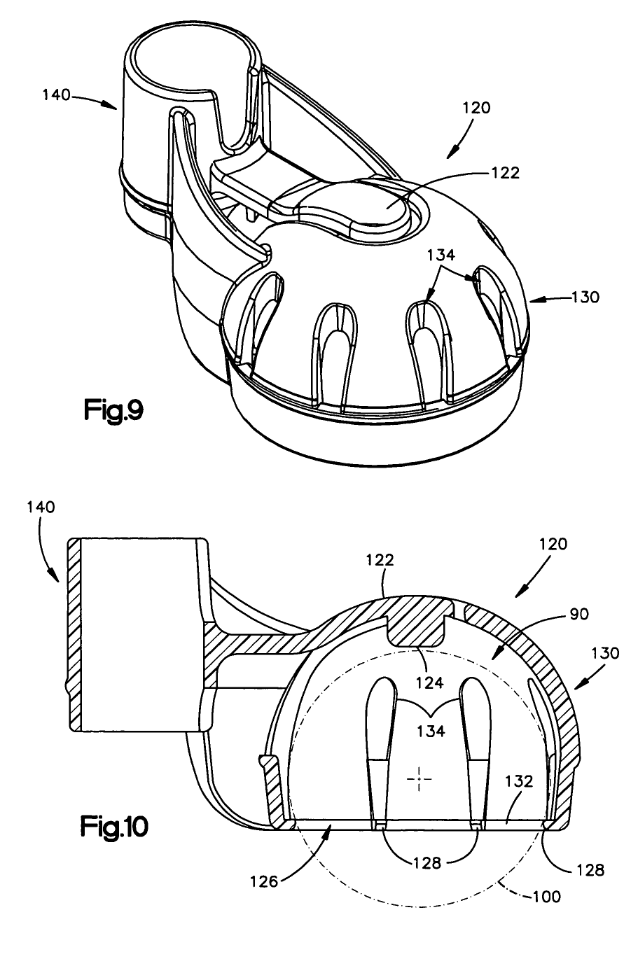

FIGS. 9 and 10 illustrate a holder 120 in accordance with a second embodiment. In the holder 120, the spring 122 and the enclosing portion 130 are formed as a single piece. As an example, this can be accomplished by molding the spring 122, the enclosing portion 130, and the leg attachment portion 140, as a single plastic component. The spring 122, which takes the place of a portion of the top wall, has a ball contact region 124. The spring 122 is designed to deflect away from the ball opening 126 when the sports ball 100 is inserted into the chamber 90 and contacts the spring. The resilient nature of the material used to construct the holder 120 provides the necessary spring force to bias the ball 100 against the retaining structure of the holder.

The holder 120 shown in FIGS. 9 and 10 also has a different retaining structure. Specifically, the retaining structure is formed as a plurality of projections 128 that are part of the enclosing portion 130 that are located along the inner surface 132 of the chamber 90 near the ball opening 126. The projections 128 effectively reduce the diameter of the opening 126 to be less than the diameter of the sports ball 100 at the sports ball's equator. In addition, the access openings 134 are a different shape and size than the access openings 86 in the holder of FIGS. 4-5, but still provide access to the ball 100, allowing the user to apply a force to the ball in the direction of the ball opening 126 of the enclosing portion 130.

FIG. 11 illustrates a holder 140 in accordance with a third embodiment of the present invention. The holder 140 (FIG. 11) includes a leg attachment portion 150, a base 160, and an enclosing portion 170. As illustrated, the leg attachment portion 150 has a rectangular cross section and includes a concave mating surface 152 which conforms to the outer surface of the lower leg portion 30. The holder 140 attaches to the lower leg portion 30 by joining the outer surface of the lower leg portion 30 with the mating surface 152 of the leg attachment portion 150 by use of fasteners, threads, adhesive, or otherwise. Alternatively, the leg attachment portion 150 could include a bore for receiving the lower leg portion 30 in the manner discussed above with respect to the glide tip 10.

When the holder 140 (FIG. 11) is attached to the lower leg portion 30 of a walker 12, the leg attachment portion 150 of the holder 140 extends outward from the leg 30 to connect to the base portion 160. In the embodiment in FIG. 11, the leg attachment portion 150 extends substantially perpendicular from the leg portion 30 and is formed as one piece with the base portion 160. Alternatively, the leg attachment portion 150 could attach to the base portion 160 via by fasteners, threads, adhesive, or otherwise. The base portion 160 (FIG. 11) is illustrated with a general cylindrical configuration having an axis that extends parallel to the axis of the leg attachment portion 150. A variety of base portion configurations, however, may be used to support the enclosing portion 170.

The enclosing portion 170 of the holder 140 includes at least two, and preferably at least three, elongated grip members 172 that attach to and extend outward from the base 160. The grip members 172 are adapted to receive and support a ball 100, such as a sports ball. As illustrated, the grip members 172 are curved with a rectangular cross section (FIG. 11). Grip members 172 having different cross-sectional shapes can be used to support the sports ball 100, including rectangular or rod-shaped.

The ball 100 fits between the grip members 172, which extend at least partially around the ball 100. When the ball 100 is within the grip members 172, the free ends 174 of the grip members contact the ball below the ball's equator, and a portion of the ball extends beyond the free ends of the grip members. Because the grip members 172 contact the ball 100 below the ball's equator, the grip members retain the ball in position relative to the base 160, without the ball falling out or off. The design of the grip members 172 and base 160 can result in the ball 100 being solely in contact with the grip members or being in contact with both the grip members and the base 160. Further, even though the grip members 172 retain the ball 100 in position, they allow the ball to rotate relatively freely within the grip members about a plurality of axes. The embodiment including the grip members 172 illustrates that the ball 100 need not be enclosed or covered for a 360° around.

The shape of the grip members 172 allows the ball 100 to compress partially if a sufficient force is applied. For example, if a sufficient force is applied to the ball 100 in a direction parallel to the axis of the walker leg 30, the force may partially compress the ball 100 against the grip members 172 and/or base 160. Further, the configuration of the grip members 172 and the base 160 allows the ball 100 to be replaced easily.

When the holder 140 is installed on the walker 12, the ball 100 engages the ground 101 and thus supports the ground engaging portion 36 of the leg 36 spaced apart from the ground 101. When sufficient downward force, such as the user's weight, is applied to the walker 12, the ball 100 compresses, bringing the ground engaging portion 36 of the lower leg portion 30 into contact with the ground 101. The ground engaging portion 36 provides a slide resistant interface with the ground 101, increasing stability of the walker 12 under load.

During the ordinary course of operation of the walker, there is a first amount of friction between the ball 100 and the ground surface 101 and a second amount of friction between the ball 100 and the holder 140. As discussed above regarding the first embodiment, if the first amount of friction is less than the second amount of friction, the ball 100 will slide across the ground surface 101. If the first amount of friction, however, is greater than the second amount of friction, the ball 100 will roll across the ground surface 101.

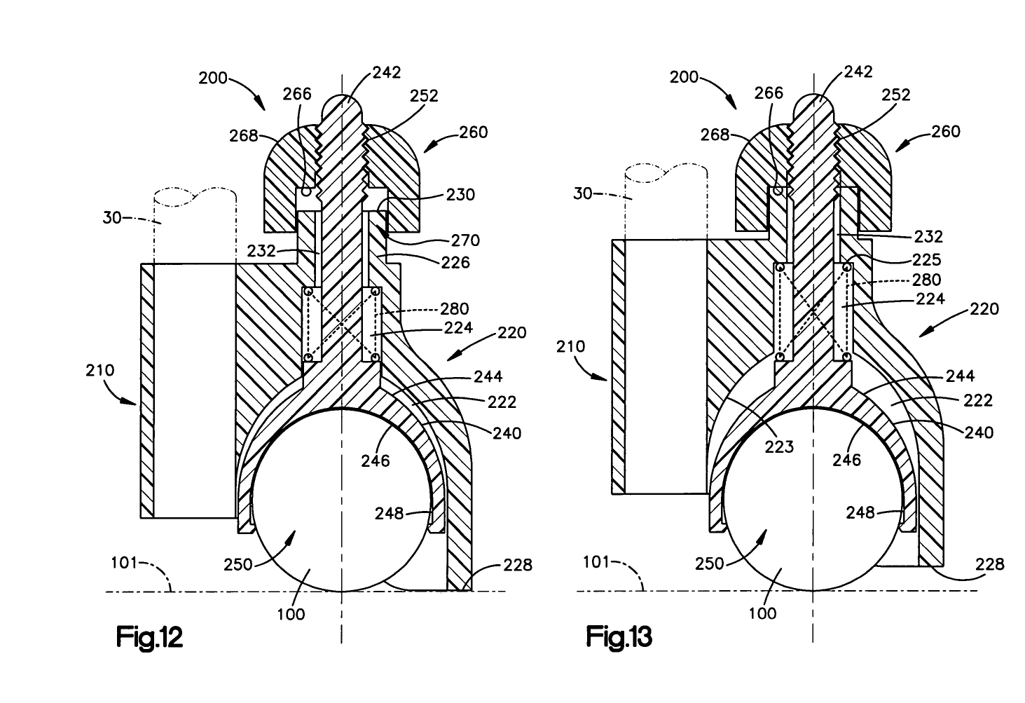

FIGS. 12-13 illustrate a holder 200 which is a fourth embodiment of the present invention. The holder 200 includes a leg attachment portion 210, an enclosing portion 220 with a ground engaging surface 228, a grip member 240 positioned within the enclosing portion 220, an adjustment knob 260, and a spring 280. The leg attachment portion 210 of the holder 200 may attach to the lower leg portion 30 in the same manner as described above for the first three embodiments. In the holder 200 the leg attachment portion 210 is formed as one piece with the enclosing portion 220. The leg attachment portion 210 may, however, attach to the enclosing portion 220 in another manner, for example, a manner similar to that described above for the first three embodiments.

The enclosing portion 220 of the holder 200 includes a cavity 222, a recessed area 224, a collar 226, and a ground engaging portion 228. The collar 226 of the enclosing portion 220 is positioned at the top of the enclosing portion 220 and includes an outer lip 230 and a stem bore 232 for receiving a stem 242 on the grip portion (discussed below). The collar 226 is generally circular in cross-section allowing the adjustment knob 260 fit over top of the collar 226. The stem bore 232 is internally linked to the cavity 222 by the recessed area 224. The cavity 222 of the enclosing portion 220 is configured to receive the grip portion 240 within the cavity. The cavity 222 includes an inner surface 223 which generally conforms with the outer surface 244 of the grip portion 240. When the grip portion 240 is fully positioned within the cavity 222, the ground engaging portion 228 of the enclosing portion 220 extends beyond the grip portion.

The grip portion 240 of the holder 200 has a similar configuration to the enclosing portion 80 in the first embodiment (FIG. 4) described above. Specifically, the grip portion 240 has a domed top wall 246 and a generally ring-shaped side wall 248 that define a chamber 250 for receiving the sports ball 100. Alternatively, the grip portion 240 could be formed as a plurality of grip members extending around the ball in a manner similar to that illustrated in the third embodiment of the invention (FIG. 11) described above. As with the enclosing portion on the first three embodiments, the grip portion 240 is adapted to retain the ball 100 in the chamber 250 via a retaining structure, for example, as described with those embodiments.

The grip portion 240 further includes a stem 242 extending perpendicular from an outer surface 244 of the grip portion 240 and through the stem bore 232 in the enclosing portion 230. The stem 242 includes external threads 252 near its upper end that engage internal threads 262 on the adjustment knob 260. The adjustment knob 260 is cup shaped and includes a stem receiving opening 264 with the internal threads 262, an inner stop surface 266, an outer surface 268 for engagement by the user, and an open end 270. The open end 270 of the adjustment knob 260 is positioned opposite the stem receiving opening 264 and over top of the collar 226 on the enclosing portion 220. The diameter of the open end 270 of the adjusting knob 260 is larger than the diameter of the collar 226, so that the adjusting knob is free to move axially along the collar.

The holder 200 also includes at least one spring positioned to act between the grip portion 240 and the enclosing portion 220. The spring may consist of an elastic device such as a metal or plastic strip or coil of wire, or an elastomer. In the embodiment of FIGS. 12-13, a coil spring 280 is positioned within the recessed area 224 of the enclosing portion 220. One end of the spring 280 engages an inner surface 225 within the recessed area 224 while the other end of the spring engages an outer surface 244 on the grip portion 240.

The holder 200 is designed to allow the grip portion 240 to move within the enclosing portion 220 between a first position (FIG. 13) and a second position (FIG. 12). In the first position, the spring 280 biases the grip portion 240 and ball 100 toward the open end of the cavity 222 such that a portion of the ball extends outward from the cavity 222. In the second position, the ball 100 and the grip portion 240 retract within the cavity 222 such that the ground engaging portion 228 of the enclosing portion 220 extends at least the same distance as the ball.

The range of movement of the grip portion 240 and the ball 100 is adjustable by use of the adjustment knob 260. The threaded engagement between the knob 260 and the stem 242 of the grip portion 240 results in the grip portion 240 and adjustment knob 260 moving together within the cavity 222. When the ball 100 and grip portion 240 are in the first position, the stop surface 266 of the adjustment knob 260 engages the collar lip 230 limiting the distance the ball and the grip portion extend from the cavity 222. By turning the adjustment knob 260, the user can modify the positional relationship between the grip portion 240 and the knob 260. Modifying the positional relationship modifies the distance the ball 100 extends from the cavity 222 when the stop surface 266 engages the collar lip 230. Thus, the range of motion of the grip member 240 and ball 100 between the first and second position, as well as the distance the 100 extends from the cavity 222, can be modified. The activation force also can be changed by changing the compressed height of the spring, for example by changing the spring material, or by shimming.

When installed on a walker leg, the glide tip assembly function generally as described in the earlier embodiments above. Specifically, the ball 100 and holder 200 are normally in a first position such that the ball engages the ground 101 with the ground engaging portion 228 of the holder 200 spaced apart from the ground. When sufficient downward force is applied to the walker, the ball 100 retracts, bringing the ground engaging portion 228 into contact with the ground 101.

During the ordinary course of operation of the walker, there is a first amount of friction between the ball 100 and the ground surface 100 and a second amount of friction between the ball and the holder 200. As discussed above regarding the first embodiment, if the first amount of friction is less than the second amount of friction, the ball 100 will slide. If the first amount of friction, however, is greater than the second amount of friction, the ball 100 will roll.

FIGS. 14-16 illustrate a holder 280 which is a fifth embodiment of the invention. The holder 280 includes a leg attachment portion, a connecting portion, and an enclosing portion 310. In the embodiment that is illustrated, the holder 280 is positioned along the axis of the leg 30 of the walker 12. FIGS. 14-16 present schematic representations of the holder 280 attaching to the lower leg portion 30. As with the typical leg of the walker, the lower leg portion 30 of the glide tip assembly 10 is tubular in construction. The tubular construction allows the holder 280 to attach to the lower leg 30 either internally or externally.

FIG. 14 illustrates a leg attachment portion configured as a projection 290 to attach internally to the lower leg portion 30. The projection 290 illustrated in FIG. 14 is cylindrical in configuration and extends away from an outer surface 312 on the enclosing portion 310 of the holder 290. The projection 290 is received by the lower end 34 of the lower leg portion 30. The diameter of the projection 290 may be slightly smaller than the diameter of the hollow inner section 292 of the lower leg portion 30 such that a frictional fit between the projection and lower leg portion can be the sole means of attachment. Alternatively, the holder 280 can be secured by fasteners, threads, adhesive, or otherwise as shown schematically at 314.

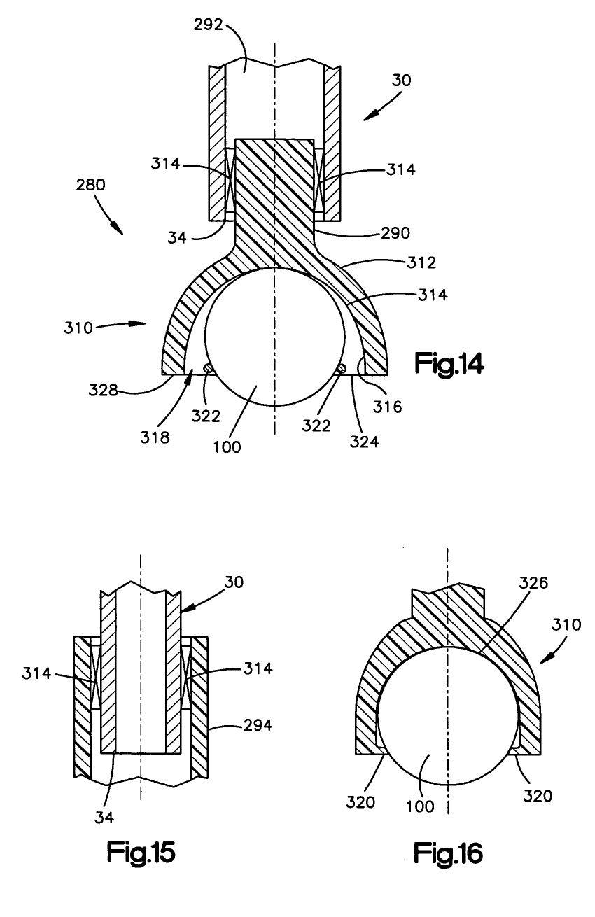

FIG. 15 illustrates a leg attachment portion configured as a sleeve 294 to attach external to the lower leg portion 30. The sleeve 294 has a tubular configuration with an inner diameter designed to receive the lower end 34 of the lower leg portion 30. The sleeve inner diameter can be slightly larger than the diameter of the lower leg portion 30 such that the frictional fit between the sleeve and the lower leg portion can be the sole means of attaching the holder 280 to the lower leg portion. Alternatively, the holder 280 can be secured by fasteners, threads, adhesive, or otherwise as shown schematically at 314.

The enclosing portion 310 of the holder 280 is attached to the leg attachment portion 290 by the connecting portion 300. In FIG. 14, the leg attachment portion 290 is illustrated as being formed as one piece with the enclosing portion 310. Alternatively, the leg attachment portion 290 could attach to the enclosing portion 310 via by fasteners, threads, adhesive, or otherwise.

The enclosing portion 310 of the holder has a similar configuration to the enclosing portion 80 in the first embodiment (FIG. 4) described above. Specifically, the enclosing portion 310 has a domed top wall 314 and a generally ring-shaped side wall 316 that define a chamber 318 for receiving the ball 100. As with previous embodiments, a retaining structure on the enclosing portion 310 is used to retain the ball 100 in the chamber 318. FIG. 16 illustrates a retaining structure configured as a lower lip 320 formed as one piece with the enclosing structure 310, similar to the retaining structure described in the first and second embodiments above. Alternatively, FIG. 14 illustrates the retaining structure as a pair of wires or pins 322 positioned chordally along the interior of the chamber 318 near the chamber's open end 324. The wires or pins 322 are positioned to contact the ball 100 below the ball's equator with each end of the wire and pins 322 securely attached to a side wall of the enclosing portion 310.

FIGS. 14 and 16 also illustrate alternative chamber designs. In FIG. 14, the chamber 318 includes additional internal space to allow the ball 100 to partially compress under load, similar to the third embodiment described above. Alternatively, in FIG. 16, the chamber's concave inner surface 326 conforms to the outer surface of the ball 100 around the ball's upper half, thus limiting the ball's ability to compress under load. If the chamber 318 is designed to allow the ball 100 to compress, a ground engaging portion 328 along the lower edge of the chamber 318 is included. Further, the inclusion of access openings (not shown) on the enclosing portion 310, similar to those described with the first embodiment, can allow the user to replace the sports ball 100 in the same manner as described above.

From the above description of the invention, those skilled in the art will perceive improvements, changes, and modifications in the invention. Such improvements, changes, and modifications within the skill of the art are intended to be included within the scope of the appended claims.

1. A glide tip for a leg of a personal mobility aid, comprising:
a holder; and
a replaceable ball supported on the leg by the holder.

2. A glide tip as set forth in claim 1 wherein the ball is rotatable about a plurality of axes relative to the holder.

3. A glide tip as set forth in claim 1 wherein the ball is retractable in the holder under load to enable engagement of the holder or the leg with the ground surface.

4. A glide tip as set forth in claim 3 further comprising a lockout mechanism for selectively limiting retraction of the ball.

5. A glide tip as set forth in claim 4 wherein the lockout mechanism comprises a stopper that is insertable between the ball and the holder.

6. A glide tip as set forth in claim 3 wherein a first portion of the holder retracts with the ball relative to a second portion of the holder.

7. A glide tip as set forth in claim 1 wherein the ball has a flocked surface

8. A glide tip as set forth in claim 7 wherein the ball is a tennis ball.

9. A glide tip as set forth in claim 8 wherein the ball is a racquet ball.

10. A glide tip as set forth in claim 1 further comprising a spring acting between the ball and the holder to bias the ball toward the ground surface.

11. A glide tip as set forth in claim 1 further comprising a height adjuster mechanism for setting the position of the ball relative to the holder.

12. A glide tip as set forth in claim 1 wherein the personal mobility aid is movable along a ground surface and a portion of the ball projects from the holder for engagement with the ground surface, and the glide tip is configured so that the ball does not roll relative to the holder when the projecting portion of the ball is in engagement with a relatively smooth ground surface and so that the ball does roll relative to the holder when the projecting portion of the ball is in engagement with a relatively rough ground surface.

13. A glide tip as set forth in claim 12 wherein the glide tip is configured with a first amount of friction between the ball and the holder that is selected to be greater than the friction between the ball and a relatively smooth ground surface, such as a tile floor, and that is selected to be greater than the friction between the ball and a relatively rough ground surface, such as carpeting.

14. A glide tip as set forth in claim 13 wherein the ball is a tennis ball.

15. A glide tip as set forth in claim 1 wherein the holder supports the ball at a position offset from the leg of the personal mobility aid.

16. A glide tip as set forth in claim 1 wherein the holder supports the ball at a position along the leg of the personal mobility aid.

17. A glide tip for attachment to a leg of a personal mobility aid, the leg having a ground engaging portion, said glide tip comprising:
a holder for attachment to the leg adjacent to the ground engaging portion of the leg; and
a ball supported by the holder for movement relative to the ground engaging portion of the leg between a first position in which the ball is engageable with the ground surface to support the ground engaging portion of the leg spaced apart from the ground and a second position in which the ground engaging portion of the leg is in contact with the ground;
the ball being rotatable about a plurality of axes relative to the holder.

18. A glide tip as set forth in claim 17 further comprising a spring acting between the ball and the holder to bias the ball toward the first position.

19. A glide tip as set forth in claim 18 wherein the spring is a leaf spring.

20. A glide tip as set forth in claim 18 wherein the holder has a concave inner surface extending at least partially around the ball and the spring is located between the ball and the holder inner surface.

21. A glide tip as set forth in claim 18 wherein the holder has an enclosing portion extending at least partially around the ball and the spring is formed as one piece with the enclosing portion of the holder.

22. A glide tip for attachment to a leg of a personal mobility aid, the leg having a ground engaging portion, said glide tip comprising:
a holder for attachment to the leg adjacent to the ground engaging portion of the leg;
a ground contact member supported by the holder for movement relative to the ground engaging portion of the leg between a first position in which the ground contact member is engageable with the ground surface to support the ground engaging portion of the leg spaced apart from the ground and a second position in which the ground engaging portion of the leg is in contact with the ground; and
a lockout mechanism for selectively limiting movement of the ground contact member in a direction from the first position to the second position.

23. The glide tip set forth in claim 22 wherein the lockout mechanism comprises a stopper that is insertable between the ground contact member and an inner surface of the holder.

24. A glide tip as set forth in claim 23 wherein the lockout mechanism is operative to eliminate substantially all movement of the ground contact member in a direction from the first position to the second position.

25. The glide tip set forth in claim 22 wherein the ground contact member includes a flocked surface.

26. The glide tip set forth in claim 25 wherein the ground contact member is a tennis ball.

27. A glide tip assembly for attachment to a leg of a personal mobility aid, comprising:
a lower leg section comprising a tube portion that is adjustably engageable with the leg of a personal mobility device and a ground engaging portion;
a holder for attachment to the lower leg section; and
a ball supported by the holder for movement relative to the ground engaging portion of the lower leg section between a first position in which the ball is engageable with the ground surface to support the ground engaging portion of the lower leg section spaced apart from the ground and a second position in which the ground engaging portion of the lower leg section is in contact with the ground,
the ball being rotatable about a plurality of axes relative to the holder.

29. A glide tip as set forth in claim 27 wherein the holder supports the ball at a position offset from the leg of the personal mobility aid.

29. A glide tip as set forth in claim 27 wherein the holder supports the ball at a position along the leg of the personal mobility aid.

30. A glide tip assembly as set forth in claim 27 wherein said lower leg section further comprises a height adjuster mechanism for setting the range of movement of the ball between the first position and the second position.

31. A glide tip assembly as set forth in claim 30 wherein the height adjuster mechanism includes a spring and a threaded adjuster member.

32. A glide tip assembly as set forth in claim 27 wherein the holder includes a tubular clamp portion for clamping the holder to the lower leg section, an arm portion extending from the clamp portion, and a ball portion for supporting the ball on the arm portion.

33. A glide tip for connection with a leg of a personal mobility aid movable along a ground surface, comprising:
a ball; and
a holder for attachment to the leg;
the ball being supported by the holder for rotational movement relative to the holder about a plurality of axes, a portion of the ball projecting from the holder for engagement with the ground surface;
the glide tip being configured so that the ball does not roll relative to the holder when the projecting portion of the ball is in engagement with a relatively smooth ground surface and so that the ball does roll relative to the holder when the projecting portion of the ball is in engagement with a relatively rough ground surface.

34. A glide tip as set forth in claim 33 wherein the glide tip is configured with a first amount of friction between the ball and the holder that is selected to be greater than the friction between the ball and a relatively smooth ground surface, such as a tile floor, and that is selected to be greater than the friction between the ball and a relatively rough ground surface, such as carpeting.

35. A glide tip as set forth in claim 34 wherein the ball is retractable in the holder under load to enable engagement of the holder with the ground surface.

36. A glide tip as set forth in claim 35 wherein the ball has a flocked surface.

37. A glide tip as set forth in claim 36 wherein the ball is a tennis ball.

38. A personal mobility aid comprising:
a plurality of legs having end portions for engagement with a ground surface; and
at least one glide tip, said glide tip aid, comprising a holder and a replaceable ball supported on the leg by the holder.

39. A personal mobility aid as set forth in claim 38 wherein said aid is a walker and wherein said ball is rotatable in said holder about a plurality of axes.

40. A personal mobility aid as set forth in claim 39 wherein said ball is a tennis ball.
